(19) United States
(12) Patent Application Publication
(10) Pub. No.: US 2022/0203507 A1
(43) Pub. Date: Jun. 30, 2022

(54) ANTI-SLIP DRIVING TOOL ADAPTED TO BE USED AT AN ANGLE OFF-AXIS TO OBJECT TO BE DRIVEN

(71) Applicant: Hong Ann Tool Industries Co., Ltd., Taichung City (TW)

(72) Inventor: Cheng-Wei SU, Taichung City (TW)

(21) Appl. No.: 17/475,521

(22) Filed: Sep. 15, 2021

(30) Foreign Application Priority Data
Dec. 29, 2020 (TW) 109146712

(51) Int. Cl. B25B 15/00

(52) U.S. Cl. CPC B25B 15/004

(57) ABSTRACT

A driving tool includes a body portion, a driving portion, and a neck portion. The driving portion defines a reference rotating axis. A distal end of the driving portion opposite to the body portion is provided with a front driving face having a first width in a radial direction of the reference rotating axis. The neck portion is disposed between the body portion and the driving portion and has a second width in the radial direction of the reference rotating axis. The second width is less than the first width.

### BACKGROUND OF THE INVENTION

The present invention relates to an anti-slip driving tool and, more particularly, to an anti-slip driving tool which is adapted to be used at an angle off-axis to an object to be driven.

Conventional driving tools such as hexagonal wrenches and screwdrivers are commonly used hand tools, which are used to drive fasteners, such as bolts or screws. However, the fastener is based on cost considerations and is a large number of consumables, the material used in the manufacture of the fastener is softer than that of the driving tool, so that the fastener will be damaged when driven by the driving tool. Furthermore, using a driving tool whose size specification does not match the listener to forcibly drive the fastener will also cause the fastener to be damaged. The driving hole of the damaged fastener is rounded out in the hex corners so that the driving tool can not effectively drive it due to relative slippage.

In view of the above, a need exists for a driving tool that mitigates and/or obviates the above drawbacks.

### BRIEF SUMMARY OF THE INVENTION

An objective of the present invention is to provide a driving tool, which includes a body portion, a driving portion, and a neck portion. The driving portion defines a reference rotating axis. A distal end of the driving portion opposite to the body portion is provided with a front driving face having a first width in a radial direction of the reference rotating axis. The neck portion is disposed between the body portion and the driving portion and has a second width in the radial direction of the reference rotating axis. The second width is less than the first width.

In an example, the front driving face is a plane perpendicular to the reference rotating axis.

In an example, an outer periphery of the driving portion in the radial direction of the reference rotating axis is provided with a first periphery face. An end of the driving portion opposite to the body portion defines a reference plane and a first rear bevel face. The reference plane is perpendicular to the reference rotating axis. The front driving face is located To in the reference plane. A side of the first rear bevel face is connected to the front driving face and forms a first side. An end of the first side is adjacent to the reference rotating axis, and another end of the first side opposite to the reference rotating axis is connected to the first periphery face. The first rear bevel face is provided with a first corner not located on the first side is and disposed between the reference plane and the body portion.

In an example, the first rear bevel face is connected to a first driving face extending in a direction parallel to the reference rotating axis. The first driving face is connected to the first corner. A side of the first driving face opposite to the first rear bevel face is connected to the front driving face.

In an example, the body portion has a third width in the radial direction of the reference rotating axis. The second width is less than the third width.

In an example, the outer periphery of the driving portion in the radial direction of the reference rotating axis is further provided with a second periphery face, a third periphery face, a fourth periphery face, a fifth periphery face, and a sixth periphery face. The first periphery face and the fourth periphery face are respectively disposed at two opposite sides of the driving portion. The second periphery face and the fifth periphery face are respectively disposed at two opposite sides of the driving portion. The third periphery face and the sixth periphery face are respectively disposed at two opposite sides of the driving portion. The end of the driving portion opposite to the body portion is further provided with a second rear bevel face, a third rear bevel face, a fourth rear bevel face, a fifth rear bevel face, and a sixth rear bevel face. A side of the second rear bevel face is connected to the front driving face and forms a second side. An end of the second side is adjacent to the reference rotating axis, and another end of the second side opposite to the reference rotating axis is connected to the second periphery face. The second rear bevel face is provided with a second corner not located on the second side and disposed between the reference plane and the body portion. The second rear bevel face is connected to a second driving face extending in a direction parallel to the reference rotating axis. The second driving face is connected to the second corner. A side of the second driving face opposite to the second rear bevel face is connected to the front driving face. A side of the third rear bevel face is connected to the front driving face and forms a third side. An end of the third side is adjacent to the reference rotating axis, and another end of the third side opposite to the reference rotating axis is connected to the third periphery face. The third rear bevel face is provided with a third corner not located on the third side and disposed between the reference plane and the body portion. The third rear bevel face is connected to a third driving face extending in a direction parallel to the reference rotating axis. The third driving face is connected to the third corner. A side of the third driving face opposite to the third rear bevel face is connected to the front driving face. A side of the fourth rear bevel face is connected to the front driving face and forms a fourth side. An end of the fourth side is adjacent to the reference rotating axis, and another end of the fourth side opposite to the reference rotating axis is connected to the fourth periphery face. The fourth rear bevel face is provided with a fourth corner not located on the fourth side and disposed between the reference plane and the body portion. The fourth rear bevel face is connected to a fourth driving face extending in a direction parallel to the reference rotating axis. The fourth driving face is connected to the fourth corner. A side of the fourth driving face opposite to the fourth rear bevel face is connected to the front driving face. A side of the fifth rear bevel face is connected to the front driving face and forms a fifth side. An end of the fifth side is adjacent to the reference rotating axis, and another end of the fifth side opposite to the reference rotating axis is connected to the fifth periphery face. The fifth rear bevel face is provided with a fifth corner not located on the fifth side and disposed between the reference plane and the body portion. The fifth rear bevel face is connected to a fifth driving face extending in a direction parallel to the reference rotating axis. The fifth driving face is connected to the fifth corner. A side of the fifth driving face opposite to the fifth rear bevel face is connected to the front driving face. A side of the sixth rear bevel face is connected to the front driving face and forms a sixth side. An end of the sixth side is adjacent to the reference rotating axis, and another end of the sixth side opposite to the reference rotating axis is connected to the sixth periphery face. The sixth rear bevel face is provided with a sixth corner not located on the sixth side and disposed between the reference plane and the body portion. The sixth rear bevel face is connected to a sixth driving face extending in a direction parallel to the reference rotating axis. The sixth driving face is connected to the sixth corner. A side of the sixth driving face opposite to the sixth rear bevel face is connected to the front driving face.

In an example, a width between the first periphery face and the fourth periphery face in the radial direction of the reference rotating axis is tapered from an end adjacent to the front driving face to another end adjacent to the neck portion. A width between the second periphery face and the fifth periphery face in the radial direction of the reference rotating axis is tapered from an end adjacent to the front driving face to another end adjacent to the neck portion. A width between the third periphery face and the sixth periphery face in the radial direction of the reference rotating axis is tapered from an end adjacent to the front driving face to another end adjacent to the neck portion.

In an example, an outer periphery of the neck portion in the radial direction of the reference rotating axis is provided with a first neck surface, a second neck surface, a third neck surface, a fourth neck surface, a fifth neck surface, and a sixth neck surface. Each of the first, second, third, fourth, fifth and sixth neck surfaces is a concave surface. An end of the first neck surface is connected to the first periphery face, and another end of the first neck surface is connected to the body portion. An end of the second neck surface is connected to the second periphery face, and another end of the second neck surface is connected to the body portion. An end of the third neck surface is connected to the third periphery face, and another end of the third neck surface is connected to the body portion. An end of the fourth neck surface is connected to the fourth periphery face, and another end of the fourth neck surface is connected to the body portion. An end of the fifth neck surface is connected to the fifth periphery face, and another end of the fifth neck surface is connected to the body portion. An end of the sixth neck surface is connected to the sixth periphery face, and another end of the sixth neck surface is connected to the body portion.

In another example, the outer periphery of the driving portion in the radial direction of the reference rotating axis is further provided with a seventh periphery face, an eighth periphery face, a ninth periphery face, a tenth periphery face, an eleventh periphery face, and a twelfth periphery face. The seventh periphery face is disposed between the first periphery face and the second periphery face and is connected to the first corner. The eighth periphery face is disposed between the second periphery face and the third periphery face and is connected to the second corner. The ninth periphery face is disposed between the third periphery face and the fourth periphery face and is connected to the third corner. The tenth periphery face is disposed between the fourth periphery face and the fifth periphery face and is connected to the fourth corner. The seventh periphery face and the tenth periphery face are respectively disposed at two opposite sides of the driving portion. The eleventh periphery face is disposed between the fifth periphery face and the sixth periphery face and is connected to the fifth corner. The eighth periphery face and the eleventh periphery face are respectively disposed at two opposite sides of the driving portion. The twelfth periphery face is disposed between the sixth periphery face and the first periphery face and is connected to the sixth corner. The ninth periphery face and the twelfth periphery face are respectively disposed at two opposite sides of the driving portion. A width between the first periphery face and the fourth periphery face in the radial direction of the reference rotating axis is equal to a width between the second periphery face and the fifth periphery face in the radial direction of the reference rotating axis, and is equal to a width between the third periphery face and the sixth periphery face in the radial direction of the reference rotating axis. A width between the seventh periphery face and the tenth periphery face in the radial direction of the reference rotating axis is equal to a width between the eighth periphery face and the eleventh periphery face in the radial direction of the reference rotating axis, and is equal to a width between the ninth periphery face and the twelfth periphery face in the radial direction of the reference rotating axis. The width between the first periphery face and the fourth periphery face in the radial direction of the reference rotating axis is less than the width between the seventh periphery face and the tenth periphery face in the radial direction of the reference rotating axis.

In another example, an outer periphery of the neck portion in the radial direction of the reference rotating axis is provided with a first neck surface, a second neck surface, a third neck surface, a fourth neck surface, a fifth neck surface, and a sixth neck surface. Each of the first, second, third, fourth, fifth and sixth neck surfaces is a concave surface. An end of the first neck surface is connected to the seventh periphery face, and another end of the first neck surface is connected to the body portion. An end of the second neck surface is connected to the eighth periphery face, and another end of the second neck surface is connected to the body portion. An end of the third neck surface is connected to the ninth periphery face, and another end of the third neck surface is connected to the body portion. An end of the fourth neck surface is connected to the tenth periphery face, and another end of the fourth neck surface is connected to the body portion. An end of the fifth neck surface is connected to the eleventh periphery face, and another end of the fifth neck surface is connected to the body portion. An end of the sixth neck surface is connected to the twelfth periphery face, and another end of the sixth neck surface is connected to the body portion.

The present invention will become clearer in light of the following detailed description of illustrative embodiments of this invention described in connection with the drawings.

### DESCRIPTION OF THE DRAWINGS

FIG. 1 is a perspective view of an anti-slip driving tool of a first embodiment according to the present invention.

FIG. 2 is another perspective view of the anti-slip driving tool of FIG. 1.

FIG. 3 is a side view of the anti-slip driving tool of FIG. 1.

FIG. 4 is a top view of the anti-slip driving tool of FIG. 1.

FIG. 5 is a cross-sectioned view of the anti-slip driving tool of FIG. 1, and illustrates the anti-slip driving tool used to drive a fastener.

FIG. 6 is a perspective view of an anti-slip driving tool of a second embodiment according to the present invention.

FIG. 7 is another perspective view of the anti-slip driving tool of FIG. 6.

FIG. 8 is a side view of the anti-slip driving tool of FIG. 6.

FIG. 9 is a top view of the anti-slip driving tool of FIG. 6.

### DETAILED DESCRIPTION OF THE INVENTION

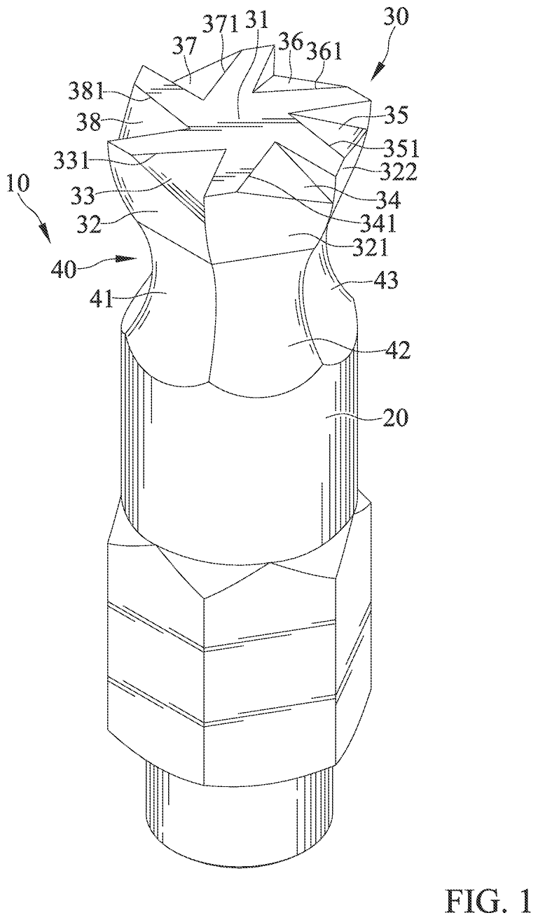

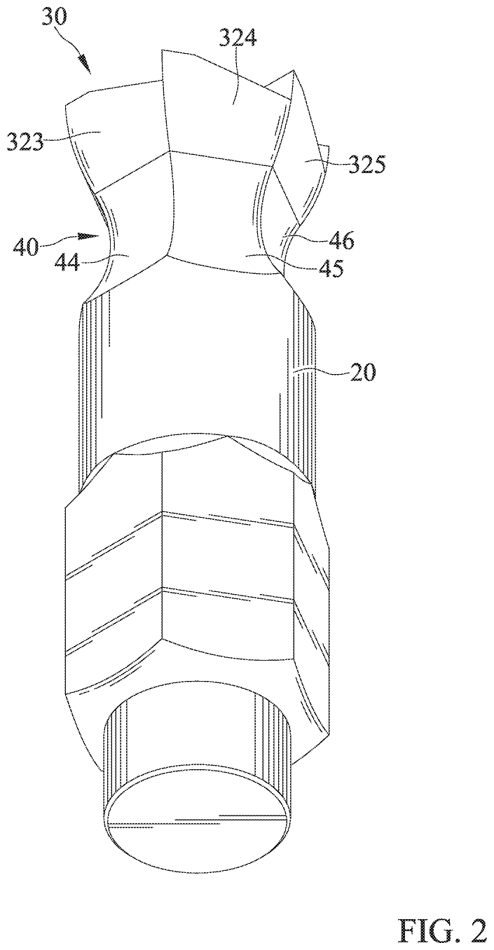

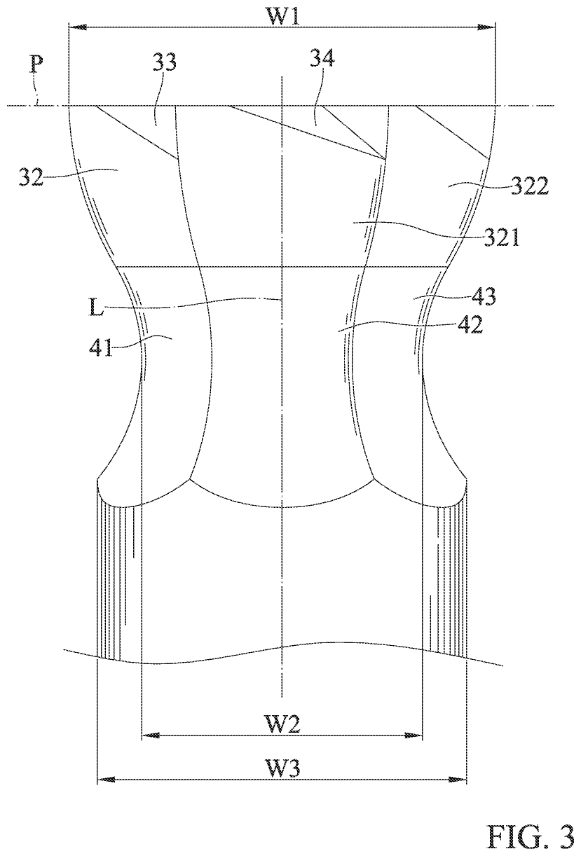

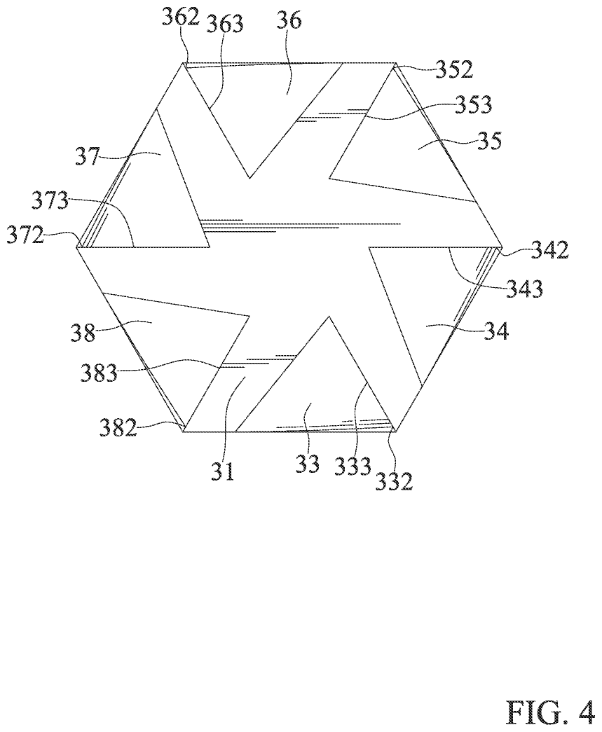

FIGS. 1-4 show an anti-slip driving tool 10 of a first embodiment according to the present invention. The anti-slip driving tool 10 includes a body portion 20, a driving portion 30, and a neck portion 40 disposed between the body portion 20 and the driving portion 30.

The driving portion 30 defines a reference rotating axis L, and a distal end of the driving portion 30 opposite to the body portion 20 is provided with a front driving face 31 having a first width W1 in a radial direction of the reference rotating axis L.

The neck portion 40 has a second width W2 in the radial direction of the reference rotating axis L, and the second width W2 is less than the first width W1.

In the embodiment, the front driving face 31 may be a plane perpendicular to the reference rotating axis L.

An outer periphery of the driving portion 30 in the radial direction of the reference rotating axis L is provided with a first periphery face 32. An end of the driving portion 30 opposite to the body portion 20 defines a reference plane P and a first rear bevel face 33. The reference plane P is perpendicular to the reference rotating axis L. The front driving face 31 is located in the reference plane P. A side of the first rear bevel face 33 is connected to the front driving face 31 and forms a first side 331. An end of the first side 331 is adjacent to the reference rotating axis L, and another end of the first side 331 opposite to the reference rotating axis L is connected to the first periphery face 32. The first rear bevel face 33 is provided with a first corner 332 not located on the first side 331 and disposed between the reference plane P and the body portion 20.

The first rear bevel face 33 is connected to a first driving face 333 extending in a direction parallel to the reference rotating axis L. The first driving face 333 is connected to the first corner 332, and a side of the first driving face 333 opposite to the first rear bevel face 33 is connected to the front driving face 31.

The body portion 20 has a third width W3 in the radial direction of the reference rotating axis L, and the second width W2 is less than the third width W3.

The outer periphery of the driving portion 30 in the radial direction of the reference rotating axis L is further provided with a second periphery face 321, a third periphery face 322, a fourth periphery face 323, a fifth periphery face 324, and a sixth periphery face 325. The first periphery face 32 and the fourth periphery face 323 are respectively disposed at two opposite sides of the driving portion 30. The second periphery face 321 and the fifth periphery face 324 are respectively disposed at two opposite sides of the driving portion 30. The third periphery face 322 and the sixth periphery face 325 are respectively disposed at two opposite sides of the driving portion 30.

The end of the driving portion 30 opposite to the body portion 20 is farther provided with a second rear bevel face 34, a third rear bevel face 35, a fourth rear bevel face 36, a fifth rear bevel face 37, and a sixth rear bevel face 38.

A side of the second rear bevel face 34 is connected to the front driving face 31 and forms a second side 341. An end of the second side 341 is adjacent to the reference rotating axis L, and another end of the second side 341 opposite to the reference rotating axis L is connected to the second periphery face 321. The second rear bevel face 34 is provided with a second corner 342 not located on the second side 341 and disposed between the reference plane P and the body portion 20. The second rear bevel face 34 is connected to a second driving face 343 extending in a direction parallel to the reference rotating axis L. The second driving face 343 is connected to the second corner 342, and a side of the second driving face 343 opposite to the second rear bevel face 34 is connected to the front driving face 31.

A side of the third rear bevel face 35 is connected to the front driving face 31 and forms a third side 351. An end of the third side 351 is adjacent to the reference rotating axis L, and another end of the third side 351 opposite to the reference rotating axis L is connected to the third periphery face 322. The third rear bevel face 35 is provided with a third corner 352 not located on the third side 351 and disposed between the reference plane P and the body portion 20. The third rear bevel face 35 is connected to a third driving face 353 extending in a direction parallel to the reference rotating axis L. The third driving face 353 is connected to the third corner 352, and a side of the third driving face 353 opposite to the third rear bevel face 35 is connected to the front driving face 31.

A side of the fourth rear bevel face 36 is connected to the front driving face 31 and forms a fourth side 361. An end of the fourth side 361 is adjacent to the reference rotating axis L, and another end of the fourth side 361 opposite to the reference rotating axis L is connected to the fourth periphery face 323. The fourth rear bevel face 36 is provided with a fourth corner 362 not located on the fourth side 361 and disposed between the reference plane P and the body portion 20. The fourth rear bevel face 36 is connected to a fourth driving face 363 extending in a direction parallel to the reference rotating axis L. The fourth driving face 363 is connected to the fourth corner 362, and a side of the fourth driving face 363 opposite to the fourth rear bevel face 36 is connected to the front driving face 31.

A side of the fifth rear bevel face 37 is connected to the front driving face 31 and forms a fifth side 371. An end of the fifth side 371 is adjacent to the reference rotating axis L, and another end of the fifth side 371 opposite to the reference rotating axis L is connected to the fifth periphery face 324. The fifth rear bevel face 37 is provided with a fifth corner 372 not located on the fifth side 371 and disposed between the reference plane P and the body portion 20. The fifth rear bevel face 37 is connected to a fifth driving face 373 extending in a direction parallel to the reference rotating axis L. The fifth driving face 373 is connected to the fifth corner 372. and a side of the fifth driving face 373 opposite to the fifth rear bevel face 37 is connected to the front driving face 31.

A side of the sixth rear bevel face 38 is connected to the front driving face 31 and forms a sixth side 381. An end of the sixth side 381 is adjacent to the reference rotating axis L, and another end of the sixth side 381 opposite to the reference rotating axis L is connected to the sixth periphery face 325. The sixth rear bevel face 38 is provided with a sixth corner 382 not located on the sixth side 381 and disposed between the reference plane P and the body portion 20. The sixth rear bevel face 38 is connected to a sixth driving face 383 extending in a direction parallel to the reference rotating axis L. The sixth driving face 383 is connected to the sixth corner 382, and a side of the sixth driving face 383 opposite to the sixth rear bevel face 38 is connected to the front driving face 31.

A width between the first periphery face 32 and the fourth periphery face 323 in the radial direction of the reference rotating axis L is tapered from an end adjacent to the front driving face 31 to another end adjacent to the neck portion 40. A width between the second periphery face 321 and the fifth periphery face 324 in the radial direction of the reference rotating axis L is tapered from an end adjacent to the front driving face 31 to another end adjacent to the neck portion 40. A width between the third periphery face 322 and the sixth periphery face 325 in the radial direction of the reference rotating axis L is tapered from an end adjacent to the front driving face 31 to another end adjacent to the neck portion 40.

An outer periphery of the neck portion 40 in the radial direction of the reference rotating axis L is provided with a first neck surface 41, a second neck surface 42, a third neck surface 43, a fourth neck surface 44, a to fifth neck surface 45, and a sixth neck surface 46. Each of the first, second, third, fourth, fifth and sixth neck surfaces 41, 42, 43, 44, 45 and 46 is a concave surface. An end of the first neck surface 41 is connected to the first periphery face 32, and another end of the first neck surface 41 is connected to the body portion 20. An end of the second neck surface 42 is connected to is the second periphery face 321, and another end of the second neck surface 42 is connected to the body portion 20. An end of the third neck surface 43 is connected to the third periphery face 322, and another end of the third neck surface 43 is connected to the body portion 20. An end of the fourth neck surface 44 is connected to the fourth periphery face 323, and another end of the fourth neck surface 44 is connected to the body portion 20. An end of the fifth neck surface 45 is connected to the fifth periphery face 324, and another end of the fifth neck surface 45 is connected to the body portion 20. An end of the sixth neck surface 46 is connected to the sixth periphery face 325, and another end of the sixth neck surface 46 is connected to the body portion 20.

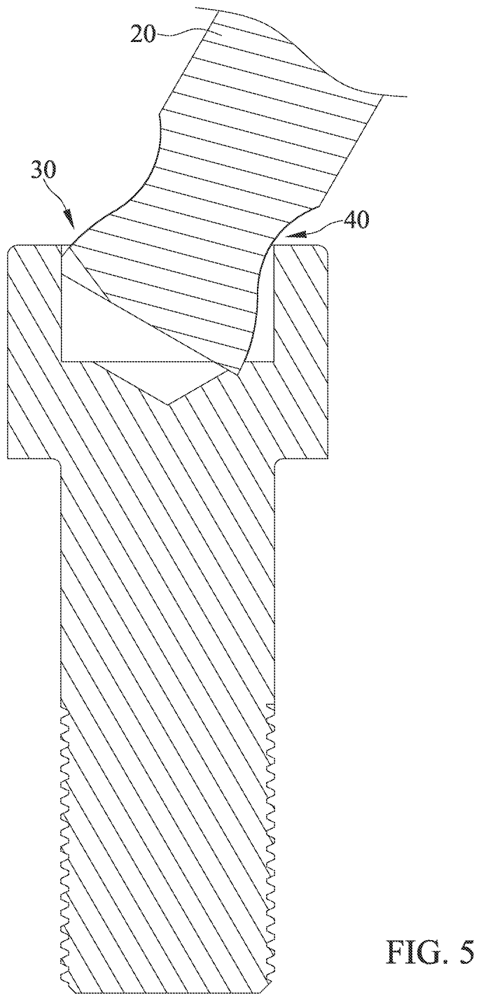

FIG. 5 shows the anti-slip driving tool 10 to be used at an angle off-axis to an object to be driven, such as a screw with a driving hole. The anti-slip driving tool 10 can drive the damaged object in an oblique direction by the above structure and achieve a good anti-slip effect, Even if the driving hole of the object is damaged, the object can still be rotated smoothly. When the anti-slip driving tool 10 is in use, the driving portion 30 is inserted into the damaged driving hole in the oblique direction, and the corners 332, 342, 352, 362, 372 and 382 of the front driving face 31 contact the inner wall of the damaged driving hole to drive the object to rotate.

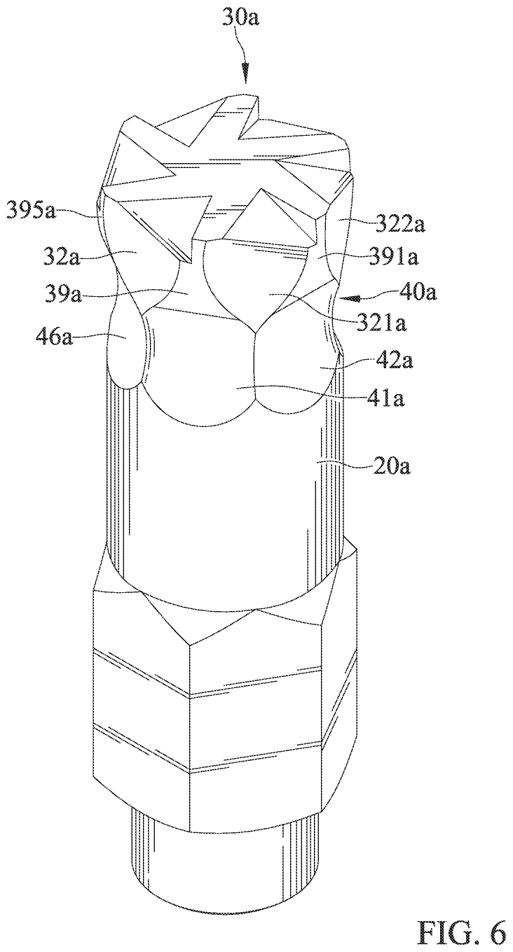

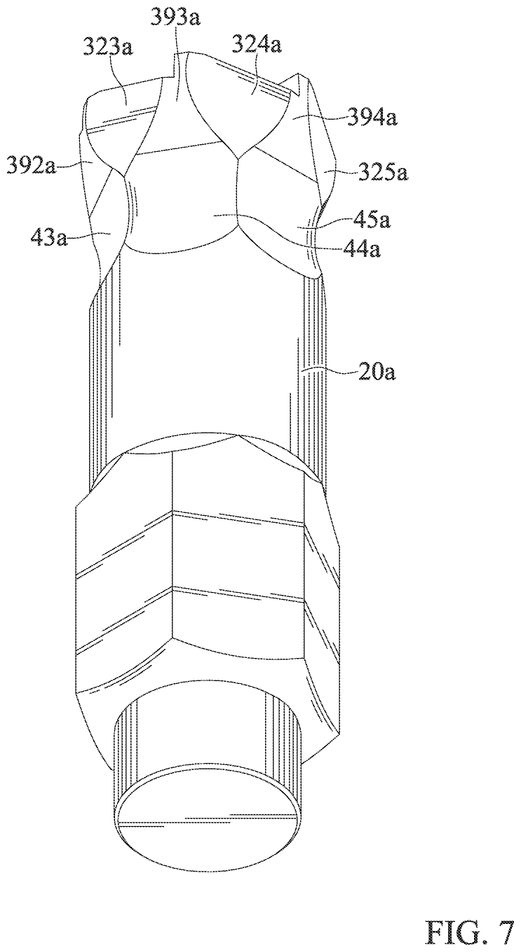

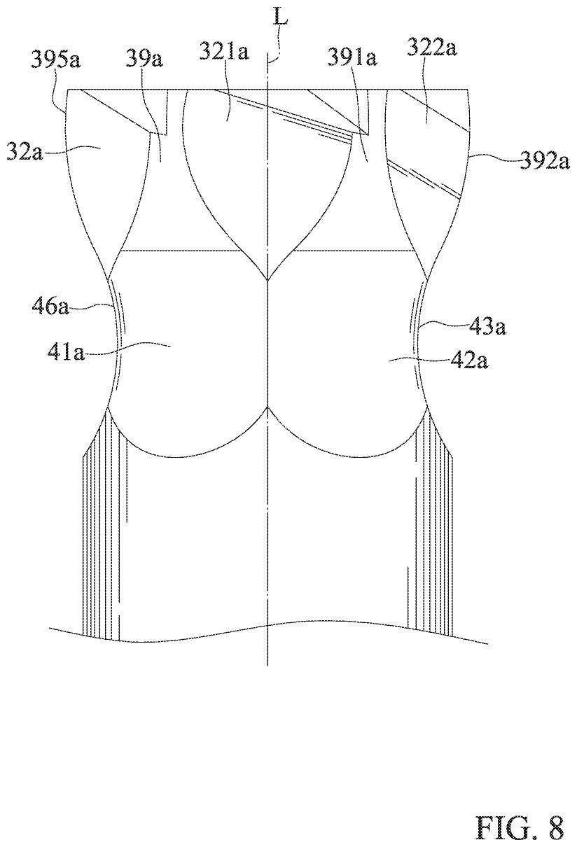

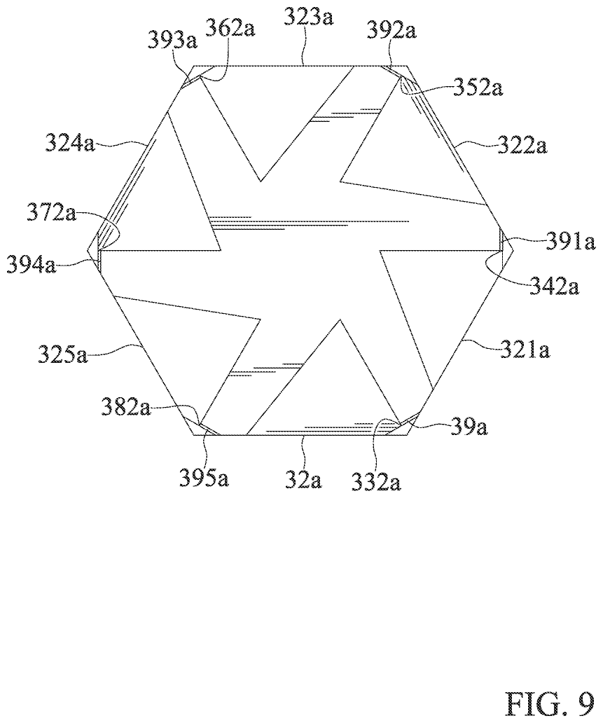

FIGS. 6-9 show an anti-slip driving tool 10 in accordance with a second embodiment of the present invention, and the same numbers are used to correlate similar components of the first embodiment, but bearing a letter a. The second embodiment is substantially the same as the first embodiment but is mainly different from the second embodiment by that the outer periphery of the driving portion 30a in the radial direction of the reference rotating axis L is further provided with a seventh periphery face 39a, an eighth periphery face 391a, a ninth periphery face 392a, a tenth periphery face 393a, an eleventh periphery face 394a, and a twelfth periphery face 395a.

The seventh periphery face 39a is disposed between the first periphery face 32a and the second periphery face 321a and is connected to the first corner 332a. The eighth periphery face 391a is disposed between the second periphery face 321a and the third periphery face 322a and is connected to the second corner 342a. The ninth periphery face 392a is disposed between the third periphery face 322a. and the fourth periphery face 323a and is connected to the third corner 352a. The tenth periphery face 393a is disposed between the fourth periphery face 323a and the fifth periphery face 324a and is connected to the fourth corner 362a. The seventh periphery face 39a and the tenth periphery face 393a are respectively disposed at two opposite sides of the driving portion 30a. The eleventh periphery face 394a is disposed between the fifth periphery face 324a and the sixth periphery face 325a and is connected to the fifth corner 372a. The eighth periphery face 391a and the eleventh periphery face 394a are respectively disposed at two opposite sides of the driving portion 30a. The twelfth periphery face 395a is disposed between the sixth periphery face 325a and the first periphery face 32a and is connected to the sixth corner 382a. The ninth periphery face 392a and the twelfth periphery face 395a are respectively disposed at two opposite sides of the driving portion 30a.

A width between the first periphery face 32a and the fourth periphery face 323a in the radial direction of the reference rotating axis L is equal to a width between the second periphery face 321a and the fifth periphery face 324a in the radial direction of the reference rotating axis L, and is equal to a width between the third periphery thee 322a and the sixth periphery face 325a in the radial direction of the reference rotating axis L.

A width between the seventh periphery thee 39a and the tenth periphery face 393a in the radial direction of the reference rotating axis L is equal to a width between the eighth periphery face 391a and the eleventh periphery face 394a in the radial direction of the reference rotating axis L, and is equal to a width between the ninth periphery face 392a and the twelfth periphery face 395a in the radial direction of the reference rotating axis L.

The width between the first periphery face 32a and the fourth periphery face 323a in the radial direction of the reference rotating axis L is less than the width between the seventh periphery face 39a and the tenth periphery face 393a in the radial direction of the reference rotating axis L.

An outer periphery of the neck portion 40a in the radial direction of the reference rotating axis L is provided with a first neck surface 41a, a second neck surface 42a, a third neck surface 43a, a fourth neck surface 44a, a fifth neck surface 45a, and a sixth neck surface 46a. Each of the first, second, third, fourth, fifth and sixth neck surfaces 41a, 42a, 43a, 44a, 45a and 46a is a concave surface.

An end of the first neck surface 41a is connected to the seventh periphery face 39a, and another end of the first neck surface 41a is connected to the body portion 20a. An end of the second neck surface 42a is connected to the eighth periphery face 391a, and another end of the second neck surface 42a is connected to the body portion 20a. An end of the third neck surface 43a is connected to the ninth periphery face 392a, and another end of the third neck surface 43a is connected to the body portion 20a. An end of the fourth neck surface 44a is connected to the tenth periphery face 393a, and another end of the fourth neck surface 44a is connected to the body portion 20a. An end of the fifth neck surface 45a is connected to the eleventh periphery face 394a, and another end of the fifth. neck surface 45a is connected. to the body portion 20a. An end of the sixth neck surface 46a is connected to the twelfth periphery face 395a, and another end of the sixth neck surface 46a is connected to the body portion 20a.

Although specific embodiments have been illustrated and described, numerous modifications and variations are still possible without departing from the scope of the invention. The scope of the invention is limited by the accompanying claims.

1. A driving tool comprising:
a body portion;
a driving portion defining a reference rotating axis, wherein a distal end of the driving portion opposite to the body portion is provided with a front driving face having a first width in a radial direction of the reference rotating axis; and
a neck portion disposed between the body portion and the driving portion and having a second width in the radial direction of the reference rotating axis, and wherein the second width is less than the first width.

2. The driving tool as claimed in claim I, wherein the front driving face is a plane perpendicular to the reference rotating axis.

3. The driving tool as claimed in claim 2, wherein an outer periphery of the driving portion in the radial direction of the reference rotating axis is provided with a first periphery face, wherein an end of the driving portion opposite to the body portion defines a reference plane and a first rear bevel face, wherein the reference plane is perpendicular to the reference rotating axis, wherein the front driving face is located in the reference plane, wherein a side of the first rear bevel face is connected to the front driving face and forms a first side, wherein an end of the first side is adjacent to the reference rotating axis, and another end of the first side opposite to the reference rotating axis is connected to the first periphery face, and wherein the first rear bevel face is provided with a first corner not located on the first side and disposed between the reference plane and the body portion.

4. The driving tool as claimed in claim 3, wherein the first rear bevel face is connected to a first driving face extending in a direction parallel to the reference rotating axis, wherein the first driving face is connected to the first corner, and wherein a side of the first driving face opposite to the first rear bevel face is connected to the front driving face.

5. The driving tool as claimed in claim 4, wherein the body portion has a third width in the radial direction of the reference rotating axis, and wherein the second. width is less than the third width.

6. The driving tool as claimed in claim 5, wherein the outer periphery of the driving portion in the radial direction of the reference rotating axis is further provided with a second periphery face, a third periphery face, a fourth periphery face, a fifth periphery face, and a sixth periphery face, wherein the first periphery face and the fourth periphery face are respectively disposed at two opposite sides of the driving portion, wherein the second periphery face and the fifth periphery face are respectively disposed at two opposite sides of the driving portion, wherein the third periphery face and the sixth periphery face are respectively disposed at two opposite sides of the driving portion;
wherein the end of the driving portion opposite to the body portion is further provided with a second rear bevel face, a third rear bevel face, a fourth rear bevel face, a fifth rear bevel face, and a sixth rear bevel face;
wherein a side of the second rear bevel face is connected to the front driving face and forms a second side, wherein an end of the second side is adjacent to the reference rotating axis, and another end of the second side opposite to the reference rotating axis is connected to the second periphery face, wherein the second rear bevel face is provided with a second corner not located on the second side and disposed between the reference plane and the body portion, wherein the second rear bevel face is connected to a second driving face extending in a direction parallel to the reference rotating axis, wherein the second driving face is connected to the second corner, and wherein a side of the second driving face opposite to the second rear bevel face is connected to the front driving face;
wherein a side of the third rear bevel face is connected to the front driving face and forms a third side, wherein an end of the third side is adjacent to the reference rotating axis, and another end of the third side opposite to the reference rotating axis is connected to the third periphery face, wherein the third rear bevel face is provided with a third corner not located on the third side and disposed between the reference plane and the body portion, wherein the third rear bevel face is connected to a third driving face extending in a direction parallel to the reference rotating axis, wherein the third driving face is connected to the third corner, and wherein a side of the third driving face opposite to the third rear bevel face is connected to the front driving face;
wherein a side of the fourth rear bevel face is connected to the front driving face and forms a. fourth side, wherein an end of the fourth side is adjacent to the reference rotating axis, and another end of the fourth side opposite to the reference rotating axis is connected to the fourth periphery face, wherein the fourth rear bevel face is provided with a fourth corner not located on the fourth side and disposed between the reference plane and the body portion, wherein the fourth rear bevel face is connected to a fourth driving face extending in a direction parallel to the reference rotating axis, wherein the fourth driving face is connected to the fourth corner, and wherein a side of the fourth driving face opposite to the fourth rear bevel face is connected to the front driving face;
wherein a side of the fifth rear bevel face is connected to the front driving face and forms a fifth side, wherein an end of the fifth side is adjacent to the reference rotating axis, and another end of the fifth side opposite to the reference rotating axis is connected to the fifth periphery face, wherein the fifth rear bevel face is provided with a fifth corner not located on the fifth side and disposed between the reference plane and the body portion, wherein the fifth rear bevel face is connected to a fifth driving face extending in a direction parallel to the reference rotating axis, wherein the fifth driving face is connected to the fifth corner, and wherein a side of the fifth driving face opposite to the fifth rear bevel face is connected to the front driving face; and
wherein a side of the sixth rear bevel face is connected to the front driving face and forms a sixth side, wherein an end of the sixth side is adjacent to the reference rotating axis, and another end of the sixth side opposite to the reference rotating axis is connected to the sixth periphery face, wherein the sixth rear bevel face is provided with a sixth corner not located on the sixth side and disposed between the reference plane and the body portion, wherein the sixth rear bevel face is connected to a sixth driving face extending in a direction parallel to the reference rotating axis, wherein the sixth driving face is connected to the sixth corner, and wherein a side of the sixth driving face opposite to the sixth rear bevel face is connected to the front driving face.

7. The driving tool as claimed in claim 6, wherein a width between the first periphery face and the fourth periphery face in the radial direction of the reference rotating axis is tapered from an end adjacent to the front driving face to another end adjacent to the neck portion, wherein a width between the second periphery face and the fifth. periphery face in the radial direction of the reference rotating axis is tapered from an end adjacent to the front driving face to another end adjacent to the neck portion, and wherein a width between the third periphery face and the sixth periphery face in the radial direction of the reference rotating axis is tapered from an end adjacent to the front driving face to another end adjacent to the neck portion.

8. The driving tool as claimed in claim 7, wherein an outer periphery of the neck portion in the radial direction of the reference rotating axis is provided with a first neck surface, a second neck surface, a third neck surface, a fourth neck surface, a fifth neck surface, and a sixth neck surface, wherein each of the first, second, third, fourth, fifth and sixth neck surfaces is a concave surface, wherein an end of the first neck surface is connected to the first periphery face, and another end of the first neck surface is connected to the body portion, wherein an end of the second neck surface is connected to the second periphery face, and another end of the second neck surface is connected to the body portion, wherein an end of the third neck surface is connected to the third periphery face, and another end of the third neck surface is connected to the body portion, wherein an end of the fourth neck surface is connected to the fourth periphery face, and another end of the fourth neck surface is connected to the body portion, wherein an end of the fifth neck surface is connected to the fifth periphery face, and another end of the fifth neck surface is connected to the body portion, and wherein an end of the sixth neck surface is connected to the sixth periphery face, and another end of the sixth neck surface is connected to the body portion.

9. The driving tool as claimed in claim 7, wherein the outer periphery of the driving portion in the radial direction of the reference rotating axis is further provided with a seventh periphery face, an eighth periphery face, a ninth periphery face, a tenth periphery face, an eleventh periphery face, and a twelfth periphery face, wherein the seventh periphery face is disposed between the first periphery face and the second periphery face and is connected to the first corner, wherein the eighth periphery face is disposed between the second periphery face and the third periphery face and is connected to the second corner, wherein the ninth periphery face is disposed between the third periphery face and the fourth periphery face and is connected to the third corner, wherein the tenth periphery face is disposed between the fourth periphery face and the fifth periphery face and is connected to the fourth corner, wherein the seventh periphery face and the tenth periphery face are respectively disposed at two opposite sides of the driving portion, wherein the eleventh periphery face is disposed between the fifth periphery face and the sixth periphery face and is connected to the fifth corner, wherein the eighth periphery face and the eleventh periphery face are respectively disposed at two opposite sides of the driving portion, wherein the twelfth periphery face is disposed between the sixth periphery face and the first periphery face and is connected to the sixth corner, wherein the ninth periphery face and the twelfth periphery face are respectively disposed at two opposite sides of the driving portion;
wherein a width between the first periphery face and the fourth periphery face in the radial direction of the reference rotating axis is equal to a width between the second periphery face and the fifth periphery face in the radial direction of the reference rotating axis, and is equal to a width between the third periphery face and the sixth periphery face in the radial direction of the reference rotating axis;
wherein a width between the seventh periphery face and the tenth periphery face in the radial direction of the reference rotating axis is equal to a width between the eighth periphery face and the eleventh periphery face in the radial direction of the reference rotating axis, and is equal to a width between the ninth periphery face and the twelfth periphery face in the radial direction of the reference rotating axis; and
wherein the width between the first periphery face and the fourth periphery face in the radial direction of the reference rotating axis is less than the width between the seventh periphery face and the tenth periphery face in the radial direction of the reference rotating axis.

10. The driving tool as claimed in claim 9, wherein an outer periphery of the neck portion in the radial direction of the reference rotating axis is provided with a first neck surface, a second neck surface, a third neck surface, a fourth neck surface, a fifth neck surface, and a sixth neck surface, wherein each of the first, second, third, fourth, fifth and sixth neck surfaces is a concave surface, wherein an end of the first neck surface is connected to the seventh periphery thee, and another end of the first neck surface is connected to the body portion, wherein an end of the second neck surface is connected to the eighth periphery thee, and another end of the second neck surface is connected to the body portion, wherein an end of the third neck surface is connected to the ninth periphery face, and another end of the third neck surface is connected to the body portion, wherein an end of the fourth neck surface is connected to the tenth periphery face, and another end of the fourth neck surface is connected to the body portion, wherein an end of the fifth neck surface is connected to the eleventh periphery face, and another end of the fifth neck surface is connected to the body portion, and wherein an end of the sixth neck surface is connected to the twelfth periphery face, and another end of the sixth neck surface is connected to the body portion.
